(19) United States
(12) Patent Application Publication
(10) Pub. No.: US 2008/0000992 A1
(43) Pub. Date: Jan. 3, 2008

(54) Bottle labeling system and method

(76) Inventor: Lisa M. Mediare, Massillon, OH (US)

Correspondence Address: WALKER & JOCKE, L.P.A., 231 SOUTH BROADWAY STREET, MEDINA, OH, 44256, US

(21) Appl. No.: 11/820,770

(22) Filed: Jun. 20, 2007

Related U.S. Application Data
(60) Provisional application No. 60/817,481, filed on Jun. 28, 2006.

(51) Int. Cl. G06K 19/06; G01K 11/12

(52) U.S. Cl. 235/494; 374/162

(57) ABSTRACT

An identification system for an assembly such as a baby bottle, including a cylindrical container and at least one selectively removable component. The identification system identifies that the cylindrical container and the removable component are associated with each other and with a particular user. The removable component may be a bottle ring or a cap member. A first elastomeric band is engageable with an outer surface of the bottle. A second elastomeric band is engageable with an outer surface of the ring or cap member. The first and second elastomeric bands include associated identification features which may include a color, a name, a symbol and combinations thereof. At least the first elastomeric band may include a temperature sensitive indicator, such as a thermochromatic dye. The identification system may include a third elastomeric band for use on the other of the ring or cap member to associate the container, the ring, and the cap member with each other and with a particular user. The components of the identification system may be packaged as a kit.

### CROSS REFERENCE TO RELATED APPLICATION

This application claims benefit pursuant to 35 U.S.C. §119(e) of U.S. Provisional Application 60/817,481 filed Jun. 28, 2006, and the disclosure of each application is herein incorporated by reference.

### TECHNICAL FIELD

This invention relates to an identification system for bottles and jars for feeding infants. In particular, the identification system includes one or more identifying elastomeric bands enabled to encircle bottle or jar structures to permit ready association between an infant and a proper bottle or jar.

### BACKGROUND ART

With the prevalent use of child care facilities, there is a need for quickly associating a bottle or baby food jar with a particular infant, and distinguishing the bottles and jars from other infants.

In particular, there are an increasing number of breast-feeding mothers who have jobs outside the home, and elect to express their milk, refrigerate, and then transport their bottles with their child for use at a child care facility. It may be the case that several infants at a particular child care center use common brands of bottles which are not readily distinguishable. Thus, there is a need to label the bottles.

Prior to feeding the infants, the bottles may be warmed. The caps and sometimes bottle rings are removed during warming. Thus there is a need to label the bottle caps and/or the rings so that the bottles are properly reassembled.

Also, breast milk has a finite useful refrigerated life. Thus, it is beneficial to label a bottle containing expressed milk with the date and time. Premixed formula also has a set refrigerated life requiring labeling the bottle with the “mix” date.

There also exists a need to test milk temperatures before feeding the infant. The care-givers often sprinkle some of the milk on their wrists or hands to monitor milk temperature. In accordance with certain inventive teachings herein, it would be beneficial to provide a thermally sensitive labeling system to apprise the care-giver of the temperature of the bottle contents. A visual indicator can alert the feeder if the contents of the bottle are too hot for administering to a child.

### DISCLOSURE OF INVENTION

It is an object of an exemplary embodiment to provide a system including a first continuous band enabled to engage an outer surface of a substantially cylindrical container, wherein the first band comprises an elastomeric material. At least one first identifying feature associated with the first band, wherein when the first band is engaged with the outer surface of the container, the container is enabled to be associated with a particular user.

It is an object of another exemplary embodiment to provide a combination including a baby bottle, at least one of a bottle ring and a cap, and at least two identifying bands, wherein the at least two identifying bands include a first continuous band enabled to releasably engage an outer surface of the bottle, wherein the first band comprises an elastomeric material and at least one first identifying feature, wherein when the first band is engaged with the outer surface of the bottle, the bottle is enabled to be associated with a particular user; and at least one second continuous band enabled to releasably engage an outer surface of at least the bottle ring or the cap, wherein the second band comprises an elastomeric material and at least one second identifying feature, wherein when the second band is engaged with the outer surface of the bottle ring or the cap, the bottle ring or the cap is enabled to be associated with the bottle and the particular user.

It is an object of an exemplary embodiment to provide a method including associating a particular user with a substantially cylindrical container by engaging an outer surface of the container with a first continuous elastomeric band having at least one first identifying feature; and associating a second member with the particular user and the container by engaging an outer surface of the second member with a second continuous elastomeric band having at least one second identifying feature.

It is a further object of exemplary embodiments to provide a kit including a first continuous elastomeric band having at least a first identifying feature enabled to be associated with a particular user, and a second continuous elastomeric band having at least a second identifying feature associated with first identifying feature and enabled to be associated with the particular user, and an identifying structure including at least another identifying feature associated with the second identifying feature, the first identifying feature, and enabled to be associated with the particular user.

Further objects of exemplary embodiments will be made apparent in the following Best Modes for Carrying Out Invention and the appended claims.

In an exemplary embodiment, at least one first identifying feature is selected from the group consisting of a color of the first band, at least one symbol embossed on a surface of the first band, at least one symbol debossed in the surface of the first band, at least one symbol printed on the surface of the first band, and combinations thereof.

In an exemplary embodiment, the first elastomeric band includes a temperature sensitive indicator such as a thermochromatic dye.

In an exemplary embodiment, the system further includes at least one second continuous band enabled to engage an outer surface of at least one member, wherein the at least one member is able to be removably engaged in supporting connection with the container, wherein the second band comprises an elastomeric material and at least one second identifying feature associated with the second band, wherein when the second band is engaged with the outer surface of the at least one member, the at least one member is enabled to be associated with the container and the particular user.

In an exemplary embodiment, the at least one second identifying feature is readily associated with the first identifying feature.

In an exemplary embodiment, the first band encompasses a changeable diameter, wherein the diameter is at least five percent (5%) larger when “stretched” than when at rest.

In an exemplary embodiment, the first band encompasses a changeable diameter, wherein the diameter is within a range of from about one and one-half (1½) inches to about three (3) inches.

In an exemplary embodiment, the system further includes at least one third continuous band enabled to engage an outer surface of at least one other member, wherein the third band comprises an elastomeric material and at least one third identifying feature associated with the third band, wherein when the third band is engaged with the outer surface of the at least one other member, the at least one other member is enabled to be associated with the container, the second member, and the particular user.

In an exemplary embodiment, the at least one third identifying feature is readily associated with the first identifying feature.

In an exemplary embodiment, the system further includes a structure including an identifying feature enabled to identify the particular user. In an exemplary embodiment, the structure may be an identification band adapted to be worn by the particular user. In another exemplary embodiment, the structure may be an identification tag adapted to be engaged in supporting connection with an item associated with the particular user.

An exemplary method includes stretching the first band prior to engaging the outer surface of the container with the first band.

An exemplary method includes engaging the outer surface of the container and the first band without the use of adhesives or hook and loop tape.

An exemplary method includes adding an edible substance to the container. An exemplary method includes heating the edible substance after engaging the outer surface of the container with the first band, and after adding the edible substance to the container.

In an exemplary embodiment, the bottle contains an edible substance such as breast milk, formula, medicine, baby food and the like.

An exemplary method includes sterilizing the container and the first band substantially simultaneously.

An exemplary method includes applying temporary identifying indicia to at least the first band.

An exemplary method includes attaching an identifying structure to a possession of the particular user.

An exemplary method includes disengaging the second member from supporting connection with the container.

An exemplary embodiment of a kit includes a third continuous elastomeric band having at least a third identifying feature associated with the second identifying feature, the first identifying feature and the particular user.

An exemplary embodiment of a kit includes an adult-sized elastomeric wristband having a wristband identifying feature associated with the first identifying feature and the particular user.

As will be appreciated, the foregoing objects and examples are exemplary and embodiments of the invention need not meet all or any of the foregoing objects, and need not include all or any of the exemplary features described above. Additional aspects and embodiments within the scope of the claims may be devised by those having skill in the art based on the teachings set forth herein.

### BRIEF DESCRIPTION OF DRAWINGS

The features and inventive aspects of exemplary embodiments will become more apparent upon reading the following detailed description, claims, and drawings, of which the following is a brief description:

FIG. 1 is an exploded view of a baby bottle assembly utilizing an embodiment of an identification system.

FIG. 2 is an identifying band for use in an embodiment of an identification system.

FIG. 3 is an identifying structure, such as an identification tag, for use in an embodiment of an identification system.

FIG. 4 illustrates a kit including components of an exemplary identification system.

### BEST MODES FOR CARRYING OUT INVENTION

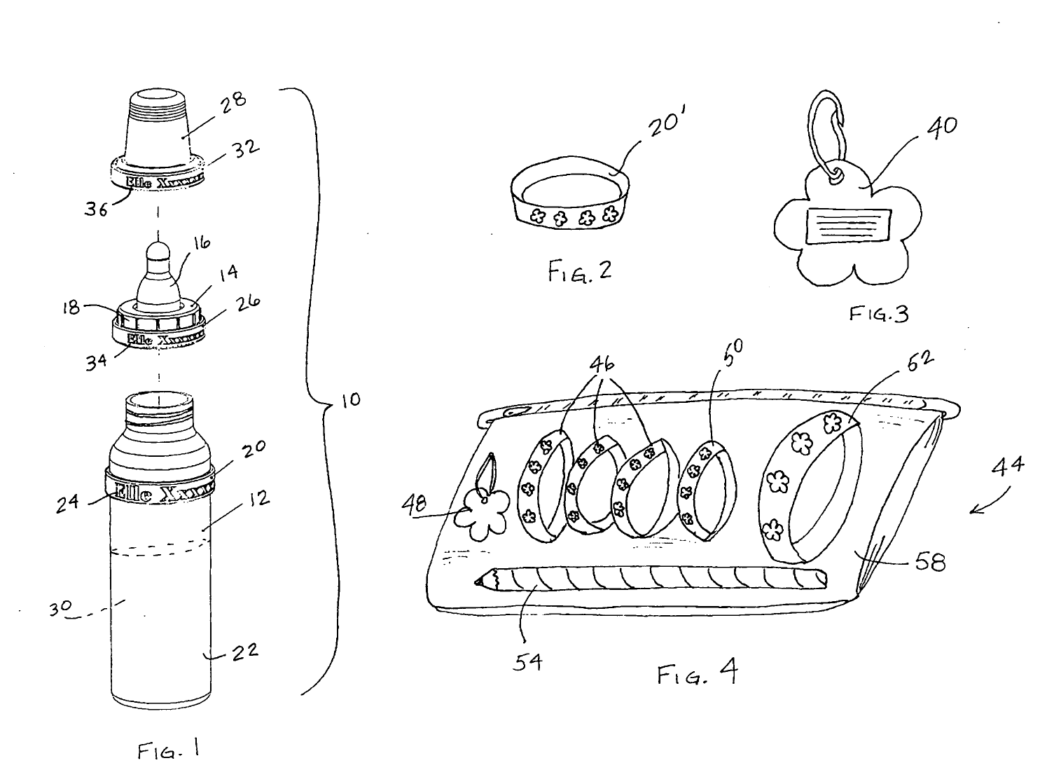

In an exemplary embodiment, there is provided a system for associating certain items with a particular user. With reference to the drawings and particularly to FIG. 1, the particular user may be an infant who requires nourishment from a baby bottle. The baby bottle assembly 10 may include a generally cylindrical container, referred to herein as body member 12. The cylindrical body 12 may be essentially round, octagonal, or other shape in cross section. In the exemplary embodiment, the bottle assembly 10 also includes a ring member 14 and a nipple 16. The ring member 14 is used to seat a flange of the nipple on the rim of the body 12 in sealing engagement. The ring member 14 and nipple 16 may be designed to cooperate as a subunit such that removal of the ring member 14 disengages the nipple 16 from the bottle.

In an exemplary embodiment, it is often desirable that the bottle and its contents be associated with a particular user, i.e., an infant requiring nourishment. It is also often desirable that the nipple be associated with the particular user. At times, it may be necessary to disengage the ring member 14 from the body 12, for example to heat the bottle contents or to clean the bottle components. In a day care setting, in particular, where there may be a plurality of infants and their associated bottles, an identification system of the type described herein may be highly desirable.

In an exemplary system, a first continuous elastomeric band 20 is sized and configured to engage the outer surface 22 of the body 12. The band 20 encompasses a changeable diameter so that it can be stretched for attachment to and removal from the body 12. In an exemplary embodiment, the first band 20 encompasses a changeable diameter, wherein the diameter is at least five percent (5%) larger when “stretched” than when at rest.

It has been found that in exemplary embodiments the general “at rest” diameter of the first band can be slightly smaller than the outer surface 22 of the body so that when the band is engaged with the body 12, the band snugly engages the body and is not easily removed by the infant being fed.

In an exemplary embodiment, the band 20, and other bands referenced below, is generally formed of a nontoxic elastomeric material. The elastomeric material allows the band to be readily stretched in order to positioned it on the body 12. The band 20 should have sufficient resiliency to be biased toward an “at rest” configuration after many uses, after undergoing several heating/cooling cycles, and after contact with detergents and other cleaning compositions. In exemplary embodiments the force produced by the resilient material of the band is sufficient to hold the band and body in engagement so as to generally prevent undesired separation. However, in other embodiments other features on the body and/or the band may be used to resist undesirable separation of the body and the band. These features may include, for example, projections, recesses, or treat configurations, which may extend on surfaces of the body, the band or both.

The exemplary first band 20 includes at least one identifying feature. The identifying feature may be a color or it may be indicia 24. The indicia 24 may be alphanumeric or other symbols embossed, debossed, or printed on the surface of the first band, or any combination thereof. In an exemplary embodiment, the identifying indicia is permanent, such as debossed symbols. In another exemplary embodiment, the identifying feature may be temporary or semipermanent, such as markings made by a grease pencil or other marker. In another exemplary embodiment, the identifying feature may be a combination of permanent and temporary or semipermanent markings. In yet another exemplary embodiment, the identifying feature may be permanent and associated information, such as date and time, may be marked on the first band with a grease pencil or other temporary marker. Other combinations of identifying features are contemplated within the scope of the present invention.

In an exemplary embodiment, the band 20 may comprise a temperature sensitive component. Thus, when the band 20 is positioned on body 12, the band 20 may indicate whether the contents of the bottle are above a threshold temperature. The temperature sensitive component may be a component of the elastomeric composition, such as a thermochromatic dye. In an exemplary embodiment, the thermochromatic dye is incorporated into the entirety of the band 20. In another exemplary embodiment, only a portion of band 20 may comprise a temperature sensitive component.

In the exemplary system, the ring member 14 is associated with the proper bottle body member 12 and the particular user through use of a second elastomeric band 26 adapted to engage an outer surface 18 of the ring member 14. If the ring member 14 and the nipple 16 are removed from the bottle body 12, for example, when the contents are being heated or cleaned, the proper members can be reassembled.

The bottle assembly 10 may further include a cap member 28 to cover the nipple 16 and minimize or prevent spillage of the substance 30 contained within the bottle. In the exemplary bottle assembly, the cap member 28 is removably engageable with the ring member 14. In an exemplary embodiment, the cap member 28 may be associated with the body member 12 and the particular user through use of a third elastomeric band 32. Of course, the illustrated embodiment is merely exemplary and other body member/ring member/cap member arrangements are possible within the scope of the inventive concepts described herein. For example, in some bottle/ring/cap designs the identification system may simply use one band on the body member and another band on the cap member.

The second band 26 includes an identifying feature, such as indicia 34 to enable the ring member 14 to be associated with the body member 12 and the particular user. In an exemplary embodiment, the identifying feature may be substantially identical to the indicia 24 on the first band 26, although any identifying feature that enables the ring member 14 to be associated with the body member 12 and the particular user may be utilized.

In an exemplary identification system, the third band 32 includes an identifying feature, such as indicia 36, that enables the cap member 28 to be associated with the body member 12 and the particular user. In an exemplary embodiment, the identifying feature of the third band 32 is substantially the same as the identifying feature of the first band 20.

In the case where a child's name is imprinted on the identification bands, it may be straightforward to associate the particular user with the correct bottle assembly components. In other cases, other means may be employed to associate a particular user with the correct bottle assembly components. This may include other arrangements of numbers, letters, symbols, colors or other human and/or machine readable features, for example.

In an exemplary embodiment, illustrated in FIG. 2, an alternate first band 20′ may include an identifying feature that is other than a user's name. For example, in the illustrated embodiment, the identifying feature includes a plurality of flowers debossed in the surface of band 20′. The first band 20′ can be readily associated with a particular user through an identifying structure 40 having a predetermined shape, such as a flower. The first band 20′ and the identifying structure 40 may both comprise a predetermined color. The identifying structure may be an identification tag that may be attached to the particular user's possession such as a diaper bag, clothing, or other possession to enable ready association of the bottle with the infant. The exemplary identification system utilizes at least a second band, for attachment to a ring member or cap member which includes a substantially similar identifying feature as the first band 20′.

A day care center, for example, may retain a record or list of which bottle identifying feature is associated with which infant. In an exemplary embodiment, the infant may wear yet another identifying band as an arm band or wrist or ankle bracelet.

In an exemplary embodiment, the identifying structure 40 may be permanently imprinted with an identifying feature, such as the infant's name, or may provide a space for an identification label, or may include at least a writable section.

The above-described embodiments are particularly directed to a baby bottle assembly. However, the same principles set forth herein may be utilized as an identification system for baby food jars, medicine bottles, and infant toys. For example, a medicine bottle may require refrigeration. An identification band may be used to associate the medicine bottle with the particular user. The identification band may also include a writable portion so that dosage time can be indicated, for example by using a grease pencil or other marking implement. After the medicine is administered, the band can be marked to indicate that the medicine was administered.

In another example, a jar of baby food may be labeled with an identification band to associate the jar with a particular user. The identification band may be used on the jar itself, or on the jar cap. It has been found that using an elastomeric identification band on a baby food jar cap is helpful when twisting the cap off the jar.

The disclosed system is further applicable to situations wherein an infant is being cared for in a temporary child care setting, such as a church nursery or fitness club child care center. The identification system may include an adult-sized identification band for the parent to wear. After the parent completes her activity, the infant, and the infant's possessions (diaper bag, bottles, baby food jars, medicine) may be easily retrieved. The identification system also provides a security check to associate the adult with the infant.

It is contemplated that all or some of the above-described components of an identification system may be packaged as a kit 44. For example, as illustrated in FIG. 4, the kit may include one or more identification bands 46 to label the bottle components, an identification structure such as an identification tag 48 and/or an additional band 50 to attach to the infant or the infant's possessions, and optionally, an adult-sized identification band 52. Each element of the kit would include at least one identifying feature to readily associate the components with each other. The kit could also include a marking implement 54, such as a grease pencil, to add temporary markings to one or more identification bands or the identification structure. In the illustrated embodiment, the components of kit 44 are arranged within a storage container 58 similar to a cosmetics bag. The illustrated embodiment is merely exemplary and other storage containers 58, if used, are contemplated within the scope of the inventive concepts described herein.

In an exemplary embodiment, there is provided an identification method. The identification system may be used to associate a particular user, such as an infant, with a cylindrical container, such as a baby bottle, by engaging an outer surface of the container body with a first continuous elastomeric band. The first band includes at least one first identifying feature. Prior to engaging the outer surface of the container with the first band, an exemplary method includes stretching the first band to increase its diameter. In an exemplary method, engaging the outer surface of the container with the first band does not include using an adhesive or using hook and loop tape.

In an exemplary method, the container and at least the first band may be sterilized substantially simultaneously. An edible substance, such as breast milk or formula, may be added to the container. An exemplary method includes heating the edible substance after engaging the outer surface of the container with the first band. An exemplary method further includes administering the edible substance to the particular user.

The exemplary method further includes associating a second member, such as a removable bottle ring or cap member, with the particular user and the container, by engaging an outer surface of the second member with a second continuous elastomeric band. The second band includes at least one second identifying feature.

An identifying structure, such as an identification tag, an arm band, an ankle bracelet, and combinations thereof may be associated with the particular user.

The components of an exemplary identification system may be packaged as a kit that may be associated with one particular user. Alternately, the components of the kit may be sterilized after use in connection with the first particular user and subsequently used with a second particular user. For example, in a temporary child care facility, after the infant is returned to the proper adult, the kit components may be collected, sterilized, and repackaged for subsequent use.

The components of an exemplary identification system may be sterilized, washed in a dishwasher, warmed in a microwave on the bottle, warmed in bottle warmers using steam or water, and can be boiled.

The identification bands of an exemplary embodiment do not include sharp edges or pieces that could fall off and injure an infant.

The exemplary identifying indicia are generally integral with the identification bands. Thus, the identifying indicia will not fade, melt off, or rub off after repetitive use.

The components of an exemplary identification system do not interfere with the functionality or performance of the baby bottle assembly, as compared to known bottle labeling collars in which the bottle/nipple seal can become damaged, interfere with nipple flow, or cause the bottle to leak.

The exemplary identification bands can be readily reused. Temporary indicia added to the identification band may be removed or replaced during subsequent use.

The elastomeric nature of the exemplary identification bands makes them suitable for use on containers of varying diameters.

Thus, the features and characteristics of the embodiments previously described achieve desirable results, eliminate difficulties encountered in the use of prior devices and systems, solve problems and may attain one or more of the objectives stated above.

In the foregoing description certain terms have been used for brevity, clarity and understanding, however no unnecessary limitations are to be implied therefrom because such terms are for descriptive purposes and are intended to be broadly construed. Moreover, the descriptions and illustrations herein are by way of examples and the invention is not limited to the details shown and described.

In the following claims any feature described as a means for performing a function shall be construed as encompassing any means capable of performing the recited function, and shall not be deemed limited to the particular means shown in the foregoing description or mere equivalents thereof.

Having described the features, discoveries and principles of the invention, the manner in which it is constructed and operated, and the advantages and useful results attained; the new and useful structures, devices, elements, arrangements, parts, combinations, systems, equipment, operations, methods, processes and relationships are set forth in the appended claims.

I claim:

1. Apparatus comprising:
a first continuous band configured to engage an outer surface of a substantially cylindrical container, wherein the first band comprises an elastomeric material; and
at least one first identifying feature operatively associated with the first band, wherein when the first band is engaged with the outer surface of the container, the at least one first identifying feature is usable to associate the container with a particular user.

2. The apparatus of claim 1 wherein at least one first identifying feature is selected from a group including of a color of the first band, at least one symbol embossed on a surface of the first band, at least one symbol debossed in the surface of the first band, at least one symbol printed on the surface of the first band, and combinations thereof.

3. The apparatus of claim 1 wherein the first elastomeric band includes a temperature sensitive indicator.

4. The apparatus of claim 3 wherein the indicator is at least one thermochromatic dye.

5. The apparatus of claim 1 and further comprising:
at least one second continuous band configured to engage an outer surface of at least one member, wherein the at least one member is configured to be removably engaged in supporting connection with the container, wherein the at least one second band comprises an elastomeric material; and
at least one second identifying feature operatively associated with the at least one second band, wherein when theat least one second band is engaged with the outer surface of the at least one member, the at least one second identifying feature associates the at least one member with the container and the particular user.

6. The apparatus of claim 5 wherein the at least one second identifying feature is readily associated with the first identifying feature.

7. The apparatus of claim 1 wherein the first band includes a changeable diameter, wherein the diameter is at least five percent (5%) larger when stretched than when released.

8. The apparatus of claim 5 further comprising:
at least one third continuous band configured to engage an outer surface of at least one other member, wherein the third band comprises an elastomeric material; and
at least one third identifying feature operatively associated with the at least one third band, wherein when the at least one third band is engaged with the outer surface of the at least one other member, the at least one third identifying feature associates the at least one other member with the container and the particular user.

9. The apparatus of claim 8 wherein the at least one third identifying feature is readily associated with the first identifying feature.

10. The apparatus of claim 1 further comprising:
a structure including an identifying feature enabled to identify the particular user.

11. The apparatus of claim 10 wherein the structure includes a continuous elastomeric band adapted to be worn by the particular user.

12. The apparatus of claim 10 wherein the structure includes a tag adapted to be engaged in supporting connection with a possession of the particular user.

13. The apparatus of claim 9 wherein the first elastomeric band includes a temperature sensitive indicator; and wherein the first band includes a changeable diameter, wherein the diameter is at least five percent (5%) larger when stretched than when released; and wherein at least one first identifying feature is selected from a group including a color of the first band, at least one symbol embossed on a surface of the first band, at least one symbol debossed in the surface of the first band, at least one symbol printed on the surface of the first band, and combinations thereof, and wherein the at least one second identifying feature is readily associated with the first identifying feature.

14. Apparatus comprising, a baby bottle, at least one of a bottle ring and a cap, and at least two identifying bands, wherein the at least two identifying bands include:
a first continuous band configured to releasably engage an outer surface of the bottle, wherein the first band comprises an elastomeric material and at least one first identifying feature, wherein when the first band is engaged with the outer surface of the bottle, the at least one first identifying feature is usable to associate the bottle with a particular user; and
at least one second continuous band configures to releasably engage an outer surface of at least one of the bottle ring and the cap, wherein the second band comprises an elastomeric material and at least one second identifying feature, wherein when the second band is engaged with the outer surface of the at least one of the bottle ring and the cap, the at least one second identifying feature associates the at least one of the bottle ring and the cap with the bottle and the particular user.

15. The apparatus of claim 14 wherein at least the first band includes a temperature sensitive indicator.

16. The apparatus of claim 15 and further comprising an edible substance contained within said bottle.

17. A method comprising:
associating a particular user with a substantially cylindrical container by engaging an outer surface of a container with a first continuous elastomeric band having at least one first identifying feature, wherein the at least one first identifying feature is usable to identify the particular user; and
associating a second member with the particular user and the container by engaging an outer surface of the second member and a second continuous elastomeric band having at least one second identifying feature, wherein the second member is removably engaged in supporting connection with the container.

18. The method of claim 17 and further comprising:
prior to engaging the outer surface of the container with the first band, stretching the band and extending the extended first band in surrounding relation of the outer surface of the container.

19. The method of 17 wherein the outer surface of the container is engaged with the first band without using an adhesive.

20. The method of claim 17 wherein the outer surface of the container is engaged with the first band without using hook and loop tape.

21. The method of claim 17, and wherein the method further comprises:
adding an edible substance to an interior area of the container.

22. The method of claim 21 and further comprising:
administering the edible substance to the particular user after engaging the outer surface of the container with the first band.

23. The method of claim 22 and further comprising:
associating an identifying structure with the particular user, wherein the identifying structure includes an arm band, an ankle bracelet, an identification tag, and combinations thereof.

24. The method of claim 23 and further comprising:
sterilizing the container; and
sterilizing at least the first band substantially simultaneously with sterilizing the container.

25. The method of claim 21 and further including:
heating the edible substance after engaging the outer surface of the container with the first band.

26. The method of claim 17 and further comprising:
applying temporary identifying indicia to at least the first band.

27. The method of claim 17 and further comprising:
attaching an identifying structure to a possession of the particular user.

28. The method of claim 17 and further comprising:
disengaging the second member from supporting connection with the container.

29. Apparatus comprising:
a first continuous elastomeric band, wherein the first band comprises at least one first identifying feature enabled to be associated with a particular user;
a second continuous elastomeric band, wherein the second band comprises at least one second identifying feature associated with the at least one first identifying feature and enabled to be associated with the particular user;
an identifying structure including at least one other identifying feature associated with the at least one second identifying feature, the at least one first identifying feature, and enabled to be associated with the particular user.

30. The apparatus of claim 29 and further comprising:
a third continuous elastomeric band, wherein the third band comprises at least one third identifying feature associated with the at least one second identifying feature, the at least one first identifying feature, and enabled to be associated with the particular user.

31. The apparatus of claim 29 and further comprising:
an elastomeric wristband having a diameter sufficient to encircle an adult wrist, wherein the wristband includes at least one wristband identifying feature associated with the at least one first identifying feature and enabled to be associated with the particular user.

32. The apparatus of claim 29 wherein the at least one first identifying feature includes a color of the first band, at least one symbol embossed on a surface of the first band, at least one symbol debossed in the surface of the first band, at least one symbol printed on the surface of the first band, and combinations thereof.

33. The apparatus of claim 32 wherein the first band includes a temperature sensitive indicator.

34. The apparatus of claim 29 wherein the identifying structure is selected from a continuous elastomeric band adapted to be worn by the particular user, an identification tag adapted to be engaged in supporting connection with a possession of the particular user, and combinations thereof.

35. The apparatus of claim 29 and further comprising a marking implement for providing a temporary marking to at least one of the first elastomeric band, the second elastomeric band, and the identifying structure.
